(19) United States
(12) Patent Application Publication
(10) Pub. No.: US 2009/0060424 A1
(43) Pub. Date: Mar. 5, 2009

(54) Optoelectronic combination connector

(75) Inventors: Michitomo Shibutani, Tokyo (JP); Takeshi Yamazaki, Tokyo (JP); Shuji Suzuki, Tokyo (JP); Tomotaka Murase, Tokyo (JP); Tsunehiro Mori, Tokyo (JP); Yuuichi Morishita, Tokyo (JP)

Correspondence Address: KUBOTERA & ASSOCIATES, LLC, Suite 202, 200 Daingerfield Road, Alexandria, VA, 22314, US

(73) Assignee: Hirose Electric Co., Ltd.

(21) Appl. No.: 12/230,374

(22) Filed: Aug. 28, 2008

(30) Foreign Application Priority Data
Aug. 29, 2007 (JP) 2007-222912

(51) Int. Cl. G02B 6/36

(52) U.S. Cl. 385/88

(57) ABSTRACT

An optoelectronic combination connector includes a plug unit having an optoelectronic converter and a receptacle unit detachably attached to the plug unit. The plug unit has a fiber securing member with a groove, so that an optical fiber cable connected to the optoelectronic converter is secured to the groove with an adhesive. In the optoelectronic combination connector, the optical fiber cable preferably has an outer cover formed of polyvinylidene fluoride or a fluoro-resin.

### BACKGROUND OF THE INVENTION AND RELATED ART STATEMENT

The present invention relates to an optoelectronic combination connector, especially to an optoelectronic combination connector, in which an optical fiber cable can be secured therein with an adhesive.

Patent Reference has disclosed an inter-board optical transmission component to achieve high-speed signal transmission within a small device such as a cellular phone. In the optical transmission component, members provided via a flexible section are connected to each other with an optical fiber cable. Accordingly, a plug unit having an optoelectronic converting function is secured on each of both end portions of the optical fiber cable through pressure bonding or resin molding, so that the plug units are attached to a receptacle unit that is mounted on a circuit board.
Patent Reference; U.S. Pat. No. 7,114,859

When an optical fiber cable is installed via a flexible section, an outer cover of the optical fiber cable may contact with a surface of a mechanical component to make a bending movement. Accordingly, when the bending movement is repeated, the outer cover of the optical fiber cable may be worn out through friction, thereby damaging the outer cover. For this reason, the optical fiber cable, especially the outer cover thereof, has to have flexibility and a sliding property that is durable against the bending movement and friction due to contact with another component. A material of the outer cover that can be suitably used under the above conditions includes a fluoro-resin, since the fluoro-resin has a low surface energy and excellent wear resistance.

The fluoro-resin has poor adhesivity, however, and it is often difficult to adhere the fluoro-resin using an adhesive. Generally, when an optical fiber cable has an outer cover made of the fluoro-resin, a surface of the optical fiber cable is first treated for improving adhesion and then secured on a component. In the surface treatment, a chemical that is harmful to a human body may be used in some cases. When a size of a device decreases, it becomes more difficult to perform pressure bonding or resin molding. Accordingly, it has been required to securely adhere a cable using an adhesive with a method simple and safe to a human body.

In view of the problems described above, an object of the present invention is to provide an optical module having a small size and a simple structure for adhering an optical fiber cable with an adhesive.

Further objects and advantages of the invention will be apparent from the following description of the invention.

### SUMMARY OF THE INVENTION

In order to attain the objects described above, according to the present invention, an optoelectronic combination connector includes a plug unit having an optoelectronic converter and a receptacle unit detachably attached to the plug unit. The plug unit has a fiber securing member with a groove, so that an optical fiber cable connected to the optoelectronic converter is secured to the groove with an adhesive.

In the optoelectronic combination connector, the optical fiber cable preferably has an outer cover formed of polyvinylidene fluoride or a fluoro-resin.

In the optoelectronic combination connector, the optoelectronic converter converts an optical signal to an electrical signal and an electrical signal to an optical signal.

In the optoelectronic combination connector, the groove may be formed of an injection moldable resin. In the optoelectronic combination connector, an opening facing the receptacle unit is preferably provided in the plug unit for accessing the groove.

In the optoelectronic combination connector, the adhesive may include a thermosetting epoxy adhesive and a cyano-acrylate adhesive.

In the optoelectronic combination connector, the plug unit may be covered with a conductive member.

According to the invention, it is possible to easily secure the optical fiber cable with an adhesive.

### BRIEF DESCRIPTION OF THE DRAWINGS

FIG. 1 is a perspective view of an optoelectronic combination connector in use according to an embodiment of the present invention;

FIG. 2 is a sectional view showing an optical fiber cable used in the optoelectronic combination connector according to the embodiment of the present invention;

FIG. 3 is a perspective view showing a plug unit and the optical fiber cable attached to the plug unit according to the embodiment of the present invention;

FIG. 4 is an enlarged perspective view showing a fiber-securing member and the optical fiber cable secured on the fiber-securing member according to the embodiment of the present invention; and

FIG. 5 is a perspective view showing a receptacle unit and a circuit board with the receptacle unit mounted thereon according to the embodiment of the present invention.

### DETAILED DESCRIPTION OF THE PREFERRED EMBODIMENTS

Hereunder, an optoelectronic combination connector according to a preferred embodiment of the invention will be described referring to the accompanying drawings.

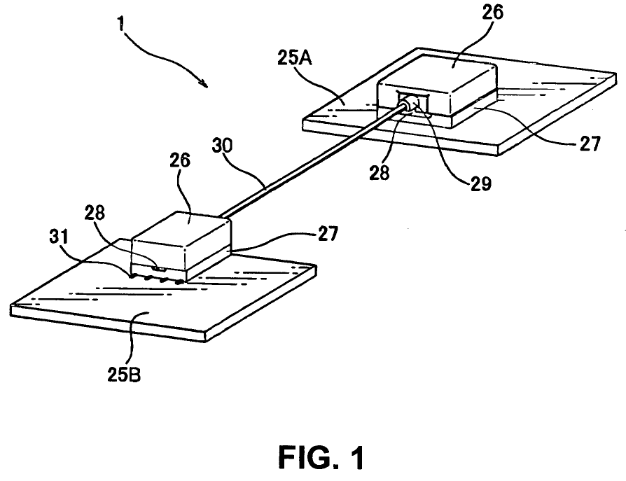

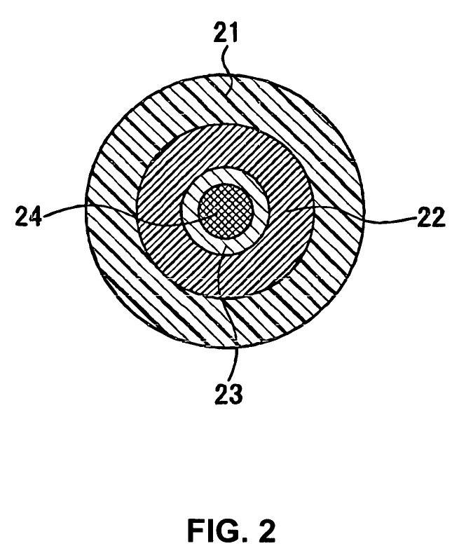

FIG. 1 is a perspective view of an optoelectronic combination connector 1 in use according to an embodiment of the present invention. FIG. 2 is a sectional view showing an optical fiber cable 30 used in the optoelectronic combination connector 1 according to the embodiment of the present invention.

As shown in FIG. 1, the optoelectronic combination connector 1 includes a pair of a box-like plug unit 26 and a flat receptacle unit 27 that can be fitted to the plug unit 26 so as to be freely attached/detached thereto/therefrom. The plug unit 26 processes both an optical signal and an electrical signal, and the receptacle unit 27 processes only an electrical signal.

In the embodiment, the plug unit 26 is fixed to one end portion of the optical fiber cable 30, and the receptacle unit 27 is mounted on, for example, a circuit board 25 (25A, 25B). In actual signal transmission, two pairs of the plug unit 26 and the receptacle unit 27 are used. Each pair is respectively connected to the end portion of the optical fiber cable 30. Then, one pair is mounted on, for example, the circuit board 25A provided on a member on a display side of a folding-type cellular phone via a bending section, and the other pair is mounted on the circuit board 25B provided on a member on an operative key side via the bending section.

In this case, it is possible to achieve signal connection through an electric signal in the circuit boards 25A and 25B and through an optical signal in the bending section. More specifically, an electric signal is input to and output from the optoelectronic combination connector 1, and the electrical signal is converted to the optical signal in the optoelectronic combination connector 1. As a result, a user does not need to take extra caution typically required for an optical device upon handling, such as safety against laser beam or cleaning an end surface of an optical fiber. Accordingly, it is possible to handle the optoelectronic combination connector 1 in a manner similar to that of a common cable having an electrical connector.

As shown in FIG. 2, the optical fiber cable 30 includes an optical fiber 30 made of quartz and including, for example, a core 24 and a clad 23 that covers the core 24; a first coat 22 that covers an outer circumference of the optical fiber (23 and 24); and the outer cover 21 as an outermost layer that covers the outer circumference.

In the embodiment, the core 24 has a diameter of, for example, about 50 μm, and the clad 23 has a diameter smaller than that of a common clad, which is about not larger than 90 μm, for example, 80 μm. Furthermore, the first coat 22 has a diameter of about 165 μm, and the outer cover 21 has a diameter of about 250 μm. A relative reflective index difference between the core 24 and the clad 23 is set at least 1.5%, for example about 1.7%, at a wavelength of 850 μm.

When the diameter of the clad 23 of the optical fiber decreases, it is possible to secure reliability even when the optical fiber is bent at a small curvature of, for example, 5 mm. In addition, the core-clad refractive index ratio is as high as about 1.7%. Accordingly, when the optical fiber cable 30 is mounted with a small curvature such as 5 mm, it is possible to minimize an optical loss, thereby maintaining optical characteristics.

In the embodiment, the outer cover 21 is formed of a material such as, for example, polyvinylidene chloride and a cable fluororesin. The materials have high sliding property and higher adhesivity in comparison with a common fluororesin, and are inferior in chemical resistance. Accordingly, it is possible to secure and adhere the optical fiber cable 30 onto another component using a common adhesive through a simple step. In addition, the materials have good moldability, so that the materials are suitable as an outer covering material of an optical cable.

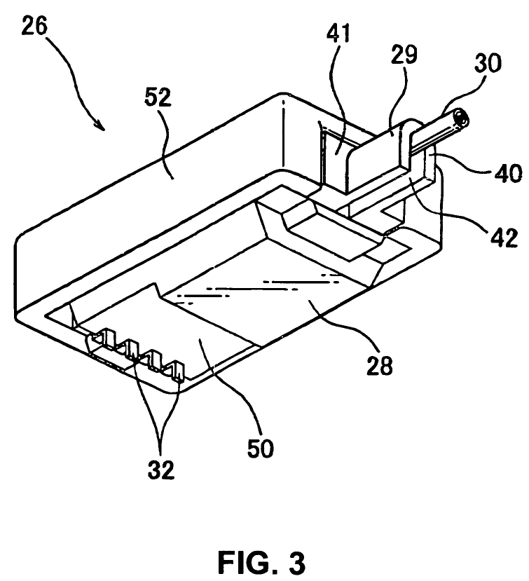

FIG. 3 is a perspective view showing the plug unit 26 and the optical fiber cable 30 attached to the plug unit 26 according to the embodiment of the present invention. As shown in FIG. 3, the plug unit 26 mainly includes a conversion module 50; a fiber securing member 29 for supporting and securing the optical fiber cable 30 secured on the conversion module 50; and a metal case 52 that covers a portion other than a bottom surface of the conversion module 50 and the fiber securing member 29.

The conversion module 50 is connected to an end portion of the optical fiber cable 30. The conversion module 50 exhibits an optoelectronic function using a optoelectronic converter (not illustrated) and an electro-optical converter (not illustrated). The optoelectronic converter and the electro-photo converter may have a multi-stage configuration such as two or more channels, and correspondingly, the optical fiber have a multi-core configuration.

In order to convert an optical signal to an electrical signal, the optoelectronic converter includes a photodiode and a trans-impedance amplifier therein. When the plug unit 26 is fitted into the receptacle unit 27, the conversion module 50 is indirectly connected to a ground wire (not illustrated) of the circuit board 25 via an electric terminal 31 of the receptacle unit 27.

A bottom surface of the conversion module 50 has an electrical connector surface 28 having an electrical terminal 32 connected to IC components. Accordingly, it is possible to supply electric power to the photodiode and the trans-impedance amplifier through the electrical connector surface 28, and to acquire an electric signal converted from an optical signal transmitted from the optical fiber cable 30. In the conversion module 50, the photodiode is closely secured so that a light-receiving surface thereof faces the optical fiber cable 30, especially the core 24 thereof, thereby receiving an optical signal from the optical fiber cable 30.

In order to convert an electrical signal to an optical signal, the electro-optical converter includes a laser diode and a laser diode driver therein. Similar to the conversion from an optical signal to an electrical signal, it is possible to supply electric power and transmit a signal to the laser diode and the laser diode driver through the electrical connector surface 28. In the conversion module 50, the laser diode is closely secured so that a light emitting point thereof faces the optical fiber, especially the core 24 thereof. Accordingly, the optical signal emitted from the laser diode is injected to the optical fiber cable 30.

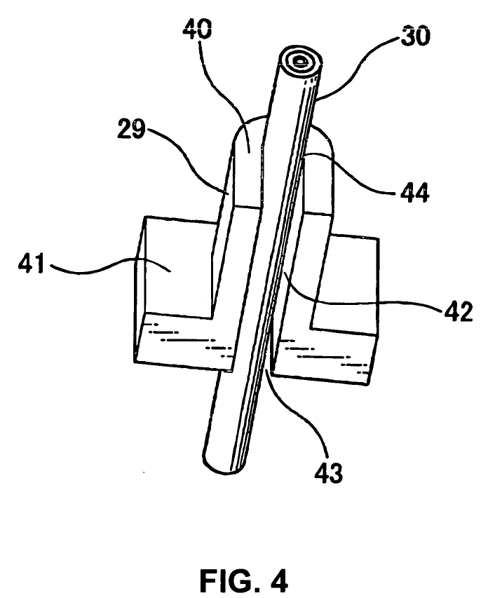

FIG. 4 is an enlarged perspective view showing the fiber-securing member 29 and a part of the optical fiber cable 30 secured on the fiber-securing member 29 according to the embodiment of the present invention.

In the embodiment, the fiber-securing member 29 is made of polycarbonate, and is arranged at an end portion of a conversion module 50, especially on a side where the optical fiber cable 30 is connected. On the side where the optical fiber cable 30 of the fiber-securing member 29 is connected, a U-shaped groove 40 having a diameter corresponding to a diameter of the outer cover of the fiber is provided.

A flat plate 41 is formed on the other side, where the optical fiber cable 30 of the fiber-securing member 29 is secured onto the conversion module 50. The optical fiber cable 30 is inserted in the groove 44 from the opening 42 that allows access to the groove 44 of the U-shaped groove 40 through a through hole 43 of the flat plate 41 that is connected to the U-shaped groove 40. Since the U-shaped groove 40 has a U-shaped structure, the optical fiber cable 30 does not have to be put therein in advance upon manufacturing the product. Accordingly, it is possible to simplify the manufacturing step.

When the plug unit 26 and the receptacle unit 27 are connected to each other, the opening 42 is attached while facing the circuit board 25, i.e., the receptacle unit 27. In addition, the optical fiber cable 30 does not bend toward the circuit board 25 upon use. Accordingly, even when the opening 42 is somewhat opened toward the circuit board 20, i.e., a side of the receptacle unit 27, there is no problem in strength for securing the optical fiber.

In the embodiment, the optical fiber cable 30 has a small diameter and is highly flexible. Accordingly, not as in a case of a normal optical connector, it is not necessary to employ a boot component to protect the optical fiber from fracture due to bending by an external force. It is not necessary to provide the U-shaped groove 40, the groove may have any shape such as, for example, a V-shape, as long as the shape can cover and hold the optical fiber.

In the embodiment, the outer cover 21 of the optical fiber cable 30 may be formed of, for example, a cable fluororesin or polyvinylidene fluoride. As a result, the optical fiber cable 30 can be easily adhered and secured in the U-shaped groove 40 made of polycarbonate.

In the embodiment, the adhesive may include, for example, a thermosetting-type epoxy adhesive manufactured by Epoxy Technology Co. and a cyano acrylate-based instant adhesive manufactured by Toa Gosei K. K., and it is also possible to use other adhesive. When the above-described two adhesives are used, it is found that a fiber tensile strength of at least 5 N is achieved in the both cases.

The metal case 52 covers a portion of the fiber-securing member 29 from outside except a surface of the flat surface 41 and a bottom surface of the conversion module 50. Since the metal case 52 has conductivity, upon fitting between the plug unit 26 and the receptacle unit 27, the plug unit 26 is electrically connected to a ground electric potential of the circuit board through contact with a part of the receptacle unit 27 (the electric terminal 31).

In addition, when the plug unit 26 is fitted in the receptacle unit 27, the metal case 52 can exhibit electromagnetic shielding effect to various IC components mounted in the plug unit 26 or the electrical terminal 31 provided in the receptacle unit 27, especially the inner terminal section 54 arranged in the receptacle unit 27.

While there is no influence of electromagnetic noise in the optical transmission path, IC components that perform the optoelectronic or electro-optical conversion may be influenced by an electromagnetic noise. Accordingly, it is effective to provide the metal case like this. With the metal case 52, noise resistance can be improved, so that a noise may not be a problem even when the high speed signal transmission, as high as about GHz, is performed.

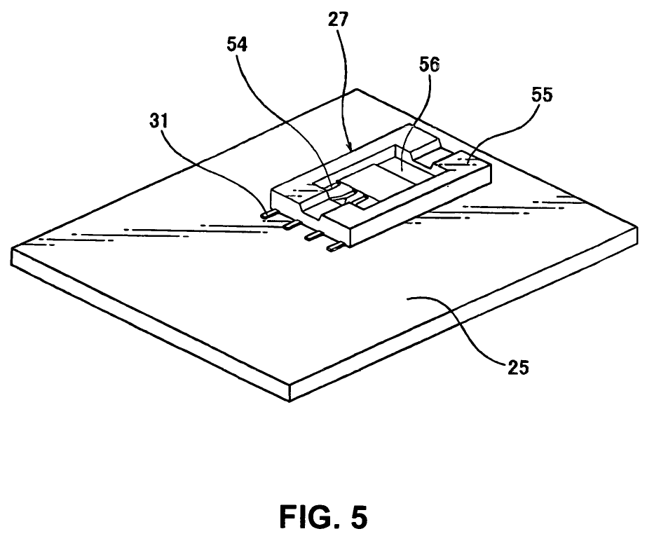

FIG. 5 is a perspective view showing the receptacle unit 27 and the circuit board 25 with the receptacle unit 27 mounted thereon according to the embodiment of the present invention.

As shown in FIG. 5, the receptacle unit 27 includes a board-securing section 55, and an electrical terminal 31 that is integrally provided with the board-securing section 55. A center part of the board-securing section 55 has a recess 56 into which a protruding electrical connector surface 28 of the conversion module 50 can fit upon fitting to the plug unit 26.

When the protruding electrical connector surface 28 is fitted in the recess 56, the electrical terminal 32 on the plug unit 26 and an electrical terminal 31 on the receptacle unit 27, especially inner terminal section 54 of the electrical terminal 31 arranged on the recess 56, are electrically connected to each other.

In the conversion from an electrical signal to an optical signal, an electricity modulation signal that corresponds to interface signal standard of the laser diode driver built in the photo-electric converter of the plug unit 26 and a driving voltage of an IC are transmitted as the electric signals from the electric terminal 31 on the receptacle unit 27 to the electric terminal 32 of the plug unit 26. Accordingly, an optical modulation signal is generated via the laser diode driver or laser diode built in the plug unit 26. The optical signal is subsequently transmitted to the optical fiber cable 30.

In the conversion from an optical signal to an electrical signal, using the electro-optical converter of the plug unit 26, an optical signal is converted to an electrical signal in a process opposite to that of the optoelectronic converter. Accordingly, an electric signal is transmitted from the electric terminal 32 of the plug unit 26 to the electric terminal of the electric terminal 31 on the receptacle unit 27. By this way, a signal can be output from the electrical terminal 31 on the electrical connector surface 28.

The present invention can be applied in various small devices using an optical fiber cable.

The disclosure of Japanese Patent Application No. 2007-222912, filed on Aug. 29, 2007 is incorporated in the application by reference.

While the invention has been explained with reference to the specific embodiments of the invention, the explanation is illustrative and the invention is limited only by the appended claims.

What is claimed is:

1. An optoelectronic combination connector, comprising:
a plug unit including an optoelectronic converter, said plug unit further including a fiber securing member with a groove so that an optical fiber cable connected to the optoelectronic converter is secured to the groove with an adhesive; and
a receptacle unit detachably attached to the plug unit.

2. The optoelectronic combination connector according to claim 1, wherein said fiber securing member includes the groove so that the optical fiber cable formed of polyvinylidene fluoride or a fluoro-resin is secured to the groove.

3. The optoelectronic combination connector according to claim 1, wherein said optoelectronic converter is adopted to convert an optical signal to an electrical signal and an electrical signal to an optical signal.

4. The optoelectronic combination connector according to claim 1, wherein said fiber securing member is formed of an injection moldable resin.

5. The optoelectronic combination connector according to claim 1, wherein said plug unit includes an opening facing the receptacle unit for accessing the groove.

6. The optoelectronic combination connector according to claim 1, wherein said fiber securing member includes the groove so that the optical fiber cable is secured to the groove with the adhesive formed of a thermosetting epoxy adhesive of a cyano-acrylate adhesive.

7. The optoelectronic combination connector according to claim 1, wherein said plug unit is covered with a conductive member.
